(19) United States
(12) Patent Application Publication
(10) Pub. No.: US 2012/0073973 A1
(43) Pub. Date: Mar. 29, 2012

(54) ANISOTROPICALLY CONDUCTIVE MEMBER

(75) Inventors: Kosuke YAMASHITA, Shizuoka (JP); Yoshinori HOTTA, Shizuoka (JP); Akio UESUGI, Shizuoka (JP)

(73) Assignee: FUJIFILM CORPORATION, Tokyo (JP)

(21) Appl. No.: 13/240,094

(22) Filed: Sep. 22, 2011

(30) Foreign Application Priority Data
Sep. 24, 2010 (JP) 2010-214098

(51) Int. Cl. C25D 1/20; C25D 1/00; B32B 3/00; B32B 3/26; B32B 5/00

(52) U.S. Cl. 205/50; 205/78

(57) ABSTRACT

An anisotropically conductive member includes an insulating base having through micropores and conductive paths formed by filling the through micropores with a conductive material, insulated from one another, and extending through the insulating base in its thickness direction, one end of each of the conductive paths exposed on one side of the insulating base, the other end of each of the conductive paths exposed on the other side thereof. The insulating base is an anodized film obtained from an aluminum substrate and the aluminum substrate contains intermetallic compounds with an average circle equivalent diameter of up to 2 μm at a density of up to 100 pcs/mm². The anisotropically conductive member dramatically increases the density of disposed conductive paths and suppresses the formation of regions having no conductive paths, and can be used as an electrically connecting member or inspection connector for electronic components.

### BACKGROUND OF THE INVENTION

The present invention relates to an anisotropically conductive member.

An anisotropically conductive member, when inserted between an electronic component such as a semiconductor device and a circuit board, then subjected to merely the application of pressure, is able to provide an electrical connection between the electronic component and the circuit board. Accordingly, such members are widely used, for example, as electrically connecting members in semiconductor devices and other electronic components and as inspection connectors when carrying out functional inspections.

In particular, owing to the remarkable degree of miniaturization that has occurred in electronically connecting members for semiconductor devices and the like, it becomes difficult to further reduce the wire diameter in conventional techniques such as wire bonding that involve the direct connection of an interconnect substrate.

This situation has drawn attention in recent years to anisotropically conductive members of a type in which an array of electrically conductive elements pass completely through a film of insulating material, or of a type in which metal balls are arranged in a film of insulating material.

Inspection connectors for semiconductor devices and the like have been used to avoid the large monetary losses that are incurred when, upon carrying out functional inspections after an electronic component such as a semiconductor device has been mounted on a circuit board, the electronic component is found to be defective and the circuit board is discarded together with the electronic component.

That is, by bringing electronic components such as semiconductor devices into electrical contact with a circuit board through an anisotropically conductive member at positions similar to those to be used during mounting and carrying out functional inspections, it is possible to perform the functional inspections without mounting the electronic components on the circuit board, thus enabling the above problem to be avoided.

An anisotropically conductive member described in JP 2008-270158 A is proposed to solve the foregoing problem.

### SUMMARY OF THE INVENTION

On the other hand, with the increased demands in recent years for miniaturization and higher functionality of electronic devices, electronic components and circuit boards are formed at a higher density and are made thinner. More specifically, fine circuits with a line width of up to 5 μm and a line-to-line spacing of up to 5 μm are now used.

In order to be able to adapt to such electronic components and circuit boards, there has arisen a need to make the outer diameter (thickness) of the conductive paths in anisotropically conductive members smaller and to uniformly arrange the conductive paths at a narrower pitch without any defect.

Under these circumstances, the inventors of the invention have made a study on the anisotropically conductive member described in JP 2008-270158 A, and found that part of the insulating base may have regions where conductive paths are not formed (deficient regions). If such deficient regions are formed even in part of the insulating base, for example, when a circuit board having fine interconnects as seen recently is contacted with an anisotropically conductive member, a region where no contact is formed between the interconnects on the circuit board and the conductive paths of the anisotropically conductive member may occur, incurring an increase in the resistivity to cause a so-called interconnect failure. As a result, application of the anisotropically conductive member to desired uses such as electrically connecting member and inspection connector is limited.

Accordingly, an object of the invention is to provide an anisotropically conductive member that dramatically increases the density of disposed conductive paths, suppresses the formation of regions having no conductive paths, and can be used as an electrically connecting member or inspection connector for electronic components such as semiconductor devices even today when still higher levels of integration have been achieved.

The inventors of the invention have made an intensive study to achieve the above object and as a result found that this object can be achieved by using an anisotropically conductive member manufactured from an aluminum substrate which contains intermetallic compounds with predetermined sizes at a predetermined density. The invention has been thus completed.

Specifically, the invention provides the following (1) to (8).

(1) An anisotropically conductive member comprising: an insulating base having through micropores and a plurality of conductive paths formed by filling the through micropores with a conductive material, insulated from one another, and extending through the insulating base in a thickness direction of the insulating base, one end of each of the conductive paths exposed on one side of the insulating base, the other end of each of the conductive paths exposed on the other side thereof,

wherein the insulating base is an anodized film obtained from an aluminum substrate and the aluminum substrate contains intermetallic compounds with an average circle equivalent diameter of up to 2 μm at a density of up to 100 pcs/mm².

(2) The anisotropically conductive member according to (1), wherein the conductive paths are formed at a density of at least 1×10⁷ pcs/mm².
(3) The anisotropically conductive member according to (1) or (2), wherein the conductive paths have diameters of 5 to 500 nm.
(4) The anisotropically conductive member according to any one of (1) to (3), wherein the insulating base has a thickness of 1 to 1,000 μm.
(5) The anisotropically conductive member according to any one of (1) to (4), wherein the aluminum substrate has an arithmetic mean roughness Ra of up to 0.1 μm.
(6) An anisotropically conductive member-manufacturing method for manufacturing the anisotropically conductive member according to any one of (1) to (5), comprising, at least:

an anodizing treatment step in which an aluminum substrate is anodized;

a perforating treatment step in which micropores formed by anodization are perforated after the anodizing treatment step to obtain an insulating base; and

a filling step in which a conductive material is filled into through micropores in the resulting insulating base after the perforating treatment step to obtain the anisotropically conductive member.

(7) The anisotropically conductive member-manufacturing method according to (6) which further comprises, after the filling step, a surface planarization step in which a top surface and a back surface are planarized by chemical mechanical polishing.
(8) The anisotropically conductive member-manufacturing method according to (6) or (7) which further comprises a trimming step after the filling step.

This invention can provide an anisotropically conductive member that dramatically increases the density of disposed conductive paths, suppresses the formation of regions having no conductive paths, and can be used as an electrically connecting member or inspection connector for electronic components such as semiconductor devices even today when still higher levels of integration have been achieved.

### BRIEF DESCRIPTION OF THE DRAWINGS

FIGS. 1A and 1B are simplified views showing a preferred embodiment of an anisotropically conductive member of the invention.

FIGS. 2A and 2B are views illustrating a method for computing the degree of ordering of micropores.

FIGS. 3A to 3D are schematic end views for illustrating anodizing treatment in the manufacturing method of the invention.

FIGS. 4A to 4D are schematic end views for illustrating filling treatment and other treatments in the manufacturing method of the invention.

FIG. 5 is a view illustrating how to compute the density of through micropores.

FIG. 6A is a cross-sectional view illustrating a device for measuring the resistivity of anisotropically conductive members in Examples and FIG. 6B is a top view of the anisotropically conductive member.

### DETAILED DESCRIPTION OF THE INVENTION

The anisotropically conductive member of the invention is described below.

In the anisotropically conductive member of the invention, conductive paths are formed in through micropores in an insulating base obtained from an aluminum substrate containing predetermined amounts of intermetallic compounds with predetermined sizes. Use of the aluminum substrate having the foregoing features enables the through micropores in the insulating base to have a more straight tubular shape while suppressing the occurrence of regions where no conductive paths are formed in the through micropores. As a result, the anisotropically conductive member obtained may have few conductive path-free regions and exhibit low resistivity.

On the other hand, when the sizes or the density of the intermetallic compounds in the aluminum substrate is outside a predetermined range, formation of through micropores in the portions containing the intermetallic compounds is impeded or conductive paths are not formed in micropores even if the micropores are formed.

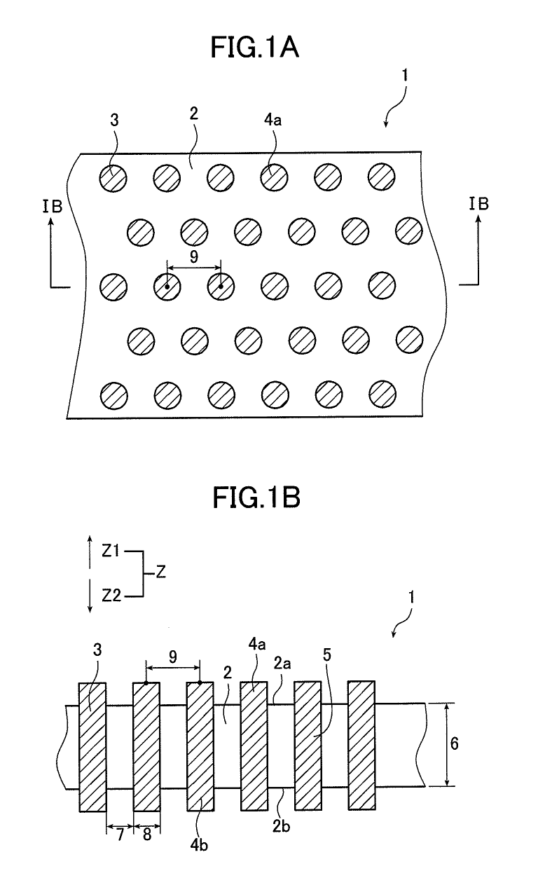

Next, the anisotropically conductive member of the invention is described with reference to FIGS. 1A and 1B.

FIGS. 1A and 1B are simplified views showing a preferred embodiment of an anisotropically conductive member of the invention; FIG. 1A being a front view and FIG. 1B being a cross-sectional view taken along the line IB-IB of FIG. 1A.

An anisotropically conductive member 1 of the invention includes an insulating base 2 and a plurality of conductive paths 3 made of a conductive material.

The conductive paths 3 extend through the insulating base 2 in a mutually insulated state and the length in the axial direction of the conductive paths 3 is equal to or larger than the length in the thickness direction Z (thickness) of the insulating base 2.

Each conductive path 3 is formed with one end exposed on one side of the insulating base 2 and the other end exposed on the other side thereof. However, each conductive path 3 is preferably formed with one end protruding from a surface 2a of the insulating base 2 and the other end protruding from a surface 2b of the insulating base 2 as shown in FIG. 1B. In other words, both the ends of each conductive path 3 preferably have protrusions 4a and 4b protruding from the main surfaces 2a and 2b of the insulating base, respectively.

In addition, each conductive path 3 is preferably formed so that at least the portion within the insulating base 2 (hereinafter also referred to as “conductive portion 5 within the base”) is substantially parallel (parallel in FIG. 1B) to the thickness direction Z of the insulating base 2. More specifically, the ratio of the centerline length of each conductive path to the thickness of the insulating base (length/thickness) is preferably from 1.0 to 1.2 and more preferably from 1.0 to 1.05.

Next, the materials and sizes of the insulating base and the conductive paths and their forming methods are described.

<Insulating Base>

The insulating base making up the anisotropically conductive member of the invention includes a through micropore-bearing anodized film obtained from an aluminum substrate. In other words, the insulating base includes an alumina film obtained by anodizing the aluminum substrate.

In the invention, in order to more reliably ensure the insulating properties in the planar direction of the electrically conductive part, the through micropores have a degree of ordering as defined by formula (i):

Degree of ordering (%)=B/A×100 (i)

(wherein A represents the total number of through micropores in a measurement region, and B represents the number of specific through micropores in the measurement region for which, when a circle is drawn so as to be centered on the center of gravity of a specific through micropore and so as to be of the smallest radius that is internally tangent to the edge of another through micropore, the circle includes the centers of gravity of six through micropores other than the specific through micropore) of preferably at least 50%, more preferably at least 70% and even more preferably at least 80%.

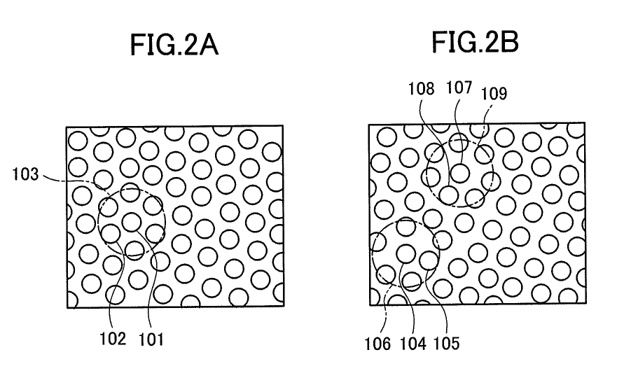

FIGS. 2A and 2B are views illustrating a method for computing the degree of ordering of through micropores. Above formula (i) is explained more fully below by reference to FIGS. 2A and 2B.

In the case of a first through micropore 101 shown in FIG. 2A, when a circle 103 is drawn so as to be centered on the center of gravity of the first through micropore 101 and so as to be of the smallest radius that is internally tangent to the edge of another through micropore (inscribed in a second through micropore 102), the interior of the circle 103 includes the centers of gravity of six through micropores other than the first through micropore 101. Therefore, the first through micropore 101 is included in B.

In the case of a first through micropore 104 shown in FIG. 2B, when a circle 106 is drawn so as to be centered on the center of gravity of the first through micropore 104 and so as to be of the smallest radius that is internally tangent to the edge of another through micropore (inscribed in a second through micropore 105), the interior of the circle 106 includes the centers of gravity of five through micropores other than the first through micropore 104. Therefore, the first through micropore 104 is not included in B.

In the case of a first through micropore 107 shown in FIG. 2B, when a circle 109 is drawn so as to be centered on the center of gravity of the first through micropore 107 and so as to be of the smallest radius that is internally tangent to the edge of another through micropore (inscribed in a second through micropore 108), the interior of the circle 109 includes the centers of gravity of seven through micropores other than the first through micropore 107. Therefore, the first through micropore 107 is not included in B.

In order that the conductive paths to be described later may have a straight tubular structure, the through micropores preferably have no branched structure. In other words, the ratio of the number of through micropores per unit area of one surface of the anodized film (A) to the number of through micropores per unit area of the other surface of the anodized film (B) (A/B) is preferably 0.90 to 1.10, more preferably 0.95 to 1.05 and most preferably 0.98 to 1.02.

In the practice of the invention, the insulating base preferably has a thickness (as shown by reference symbol 6 in FIG. 1B) of from 1 to 1,000 μm, more preferably from 5 to 500 μm and even more preferably from 10 to 300 μm. At an insulating base thickness within the foregoing range, the insulating base can be handled with ease.

In the practice of the invention, the width between neighboring conductive paths (the portion represented by reference symbol 7 in FIG. 1B) in the insulating base is preferably at least 10 nm, and more preferably from 20 to 200 nm. At a width between neighboring conductive paths of the insulating base within the foregoing range, the insulating base functions fully as an insulating barrier.

In the invention, the conductive paths are preferably formed in at least 95% of the through micropores in the insulating base in terms of the resistance to conduction and the suppression of the incorporation of impurities. The ratio of formation of conductive paths is more preferably at least 98%. The ratio of formation of conductive paths is most preferably 100% although the upper limit is not particularly limited.

The ratio of formation of conductive paths refers to a ratio of through micropores in the insulating base where the conductive paths are formed. More specifically, the ratio of formation of conductive paths is represented by the formula: number of through micropores in the insulating base where the conductive paths are formed/total number of through micropores before the formation of the conductive paths.

The ratio of formation of conductive paths (%) is obtained by observing the top surface and the back surface of an anisotropically conductive member by FE-SEM, determining the ratio of the number of through micropores where the conductive paths are formed to the total number of through micropores within a field of view (number of through micropores filled with a conductive material/total number of through micropores) for the top surface and back surfaces and averaging the determined ratio.

[Anodized Film Obtained from Aluminum Substrate]

In the practice of the invention, the insulating base is an anodized film obtained from an aluminum substrate and can be manufactured by anodizing the aluminum substrate and perforating the micropores formed by anodization. The anodizing treatment step and the perforating treatment step will be described in detail in the anisotropically conductive member-manufacturing method of the invention to be referred to later.

The micropores refer to pores which are formed during anodizing treatment on an aluminum plate and do not entirely extend through the film. Pores which were made to entirely extend through the film as a result of perforating treatment to be described later are called through micropores.

(Aluminum Substrate)

The aluminum substrate used in the invention contains intermetallic compounds at a density of up to 100 pcs/mm². As described above, an anisotropically conductive member in which conductive paths are formed in the through micropores of the insulating base at a high ratio can be obtained using the aluminum substrate having the foregoing properties.

The intermetallic compounds as used herein are compounds crystallized in aluminum alloys as eutectic compounds such as FeAl₃, FeAl₆, α-AlFeSi, TiAl₃ and CuAl₂ formed from some of aluminum alloy ingredients which do not enter into solid solution in aluminum (The Fundamentals of Aluminum Materials and Industrial Technology, Japan Aluminum Association, page 32). The intermetallic compounds are usually composed of two or more metallic elements and it is known that the proportion of the constituent atoms is not necessarily a stoichiometric proportion.

Exemplary intermetallic compounds containing two or more metallic elements include those containing two elements such as Al₃Fe, Al₆Fe, Mg₂Si, MnAl₆, TiAl₃ and CuAl₂; those containing three elements such as α-AlFeSi and β-AlFeSi; and those containing four elements such as α-AlFeMnSi and β-AlFeMnSi. Of these, CuAl₂ and Al₃Fe are preferred in terms of further improving the ratio of formation of conductive paths in the through micropores.

In the practice of the invention, the intermetallic compounds contained in the aluminum substrate have an average circle equivalent diameter of up to 2 μm. The average circle equivalent diameter is preferably up to 1 μm and more preferably up to 0.5 μm in terms of further improving the ratio of formation of conductive paths in the through micropores. The average circle equivalent diameter is not particularly limited for the lower limit and is preferably as small as possible. The average circle equivalent diameter is preferably at least 0.1 μm under industrial manufacturing conditions.

When the average circle equivalent diameter is outside the foregoing range (exceeds 2 μm), regions where no through micropores are formed in the insulating base or the micropores formed are not filled with a conductive material occur to limit the application to predetermined uses such as interconnects with a narrow pitch.

The circle equivalent diameter is a value calculated as the diameter of a circle having the same area as that of the intermetallic compound particle in the SEM image.

The average circle equivalent diameter is measured as follows: First, a surface and a cross-sectional surface of the aluminum substrate are observed by SEM (7400F available from JEOL Ltd.) in the back-scattered electron imaging mode at an acceleration voltage of 12 kV and an observation magnification of 10,000× in a plurality of fields of view with a measured area of 0.1 mm². The circle equivalent diameter of at least 100 intermetallic compound particles is measured and the average of the measurements is calculated to obtain the average circle equivalent diameter.

The intermetallic compounds have a density of up to 100 pcs/mm², more preferably up to 80 pcs/mm² and even more preferably up to 50 pcs/mm². The density is not particularly limited for the lower limit and is preferably as small as possible and more preferably 0 pce/mm³.

When the intermetallic compound density is outside the foregoing range (exceeds 100 pcs/mm²), regions where no through micropores are formed in the insulating base or the micropores formed are not filled with a conductive material occur, leading to an increase in the resistivity of the resulting anisotropically conductive member to limit the application to predetermined uses.

The intermetallic compound density is measured as follows: First, a surface and a cross-sectional surface of the aluminum substrate are observed by SEM (7400F available from JEOL Ltd.) in the back-scattered electron imaging mode at an observation magnification of 1,000× in a plurality of fields of view with a measured area of 0.1 mm². The number of intermetallic compound particles is counted based on the observation results to obtain the density.

The arithmetic mean roughness Ra of the aluminum substrate is not particularly limited and is preferably up to 0.1 μm and more preferably up to 0.05 μm because unbranched micropores can be formed to further improve the ratio of formation of conductive paths in the through micropores while further reducing the resistivity of the resulting anisotropically conductive member. The arithmetic mean roughness Ra is not particularly limited for the lower limit and is preferably as small as possible and is more preferably 0.

The arithmetic mean roughness Ra of the aluminum substrate may be measured by, for example, SURFCOM (Tokyo Seimitsu Co., Ltd.).

The aluminum substrate for use in the invention may be a commercially available product or be manufactured by a predetermined method.

[Method of Manufacturing Aluminum Substrate]

The aluminum substrate is preferably manufactured by the following steps although its manufacturing method is not particularly limited.

(Casting step) Step for forming an aluminum substrate from an aluminum alloy melt;
(Cold rolling step) Step for reducing the thickness of the aluminum substrate obtained in the casting step;
(Intermediate annealing step) Step for heat-treating the aluminum substrate obtained in the cold rolling step; and
(Finish cold rolling step) Step for reducing the thickness of the aluminum substrate after the intermediate annealing step.

The materials used in the respective steps and the procedures are described below in detail.

[Aluminum Alloy Melt]

The aluminum substrate manufactured by the foregoing manufacturing method is preferably prepared from an aluminum alloy melt (hereinafter also referred to as the “aluminum melt”) which contains at least iron and silicon and may contain copper as one of impurities.

Silicon is an element which is contained as an inevitable impurity in the aluminum ingot serving as the starting material. A very small amount of silicon is often intentionally added to prevent variations due to starting material differences. Silicon is present in the state of solid solution in aluminum or as an intermetallic compound or a single deposit.

In the practice of the invention, the aluminum melt preferably contains silicon in an amount of up to 0.01 wt %, more preferably up to 0.008 wt % and even more preferably up to 0.002 wt %.

Iron increases the mechanical strength of aluminum alloys and exerts a large influence on the strength but enters into solid solution in aluminum in a small amount and is almost present as intermetallic compounds.

In the practice of the invention, the aluminum melt preferably contains iron in an amount of 0.01 to 0.03 wt %.

Copper enters with great ease into solid solution and only a part of the copper is present as intermetallic compounds.

In the invention, the aluminum melt preferably contains copper in an amount of 0.001 to 0.004 wt %.

To prevent crack formation during casting, the aluminum melt may include elements which have a grain refining effect such as titanium and boron but remaining crystal grains may hinder the uniform growth of the anodized film.

In the practice of the invention, the aluminum melt may contain, for example, titanium in an amount of 0.001 to 0.003 wt %. The aluminum melt may also contain boron in an amount of 0.001 to 0.002 wt %.

The balance of the aluminum melt is aluminum and inevitable impurities. Examples of such impurities include magnesium, manganese, zinc, chromium, zirconium, vanadium, and beryllium. The aluminum melt may contain these impurities in amounts of up to 0.001 wt %.

Most of the inevitable impurities originate from the aluminum ingot. If the inevitable impurities are what is present in an ingot having an aluminum purity of 99.999 wt %, they will not compromise the intended effects of the invention. The inevitable impurities may be, for example, impurities included in the amounts mentioned in Aluminum Alloys: Structure and Properties, by L. F. Mondolfo (1976).

[Casting Step]

The casting step is a step for forming the aluminum substrate from the aluminum alloy melt.

The process used in this step is not particularly limited and semicontinuous casting (DC (direct chill casting) process) and continuous casting and rolling (CC (continuous casting) process) may be used.

In the case of DC casting, molten metal is flowed into the lower mold, where it is cooled and solidified. The lower mold is then lowered to further cool the molten metal with water from the lateral side to solidify it to the central portion. In this case, the cooling rate is said to be 0.5 to 10° C./s.

In order to form intermetallic compounds in the invention through DC casting, it is desirable to reduce the thickness of the resulting ingot to 10 cm or less and to increase the cooling rate to 10° C./s or more.

DC casting is preferably performed by the following three steps to form the aluminum substrate:

(1) semicontinuous casting step for forming an ingot from an aluminum alloy melt;
(2) scalping step for scalping the ingot formed in the semicontinuous casting step; and
(3) hot rolling step for rolling the scalped ingot to obtain a rolled plate.

The procedures of the steps (1) to (3) are described in paragraphs [0040] to [0046] of JP 2010-058315 A.

The continuous casting and rolling process is a process in which the foregoing aluminum melt is rolled as it is solidified to form the aluminum substrate, examples thereof including a twin-roll process and a belt casting process.

More specifically, a twin-roll process which involves feeding the foregoing aluminum melt through a melt feed nozzle between a pair of cooling rollers and rolling the aluminum melt while solidifying between the pair of cooling rollers to form the aluminum substrate is advantageously used.

The continuous casting and rolling process is characterized by the high cooling rate (solidification rate) of the aluminum melt during its solidification, and the cooling rate is preferably 100 to 800° C./s and more preferably 400 to 600° C./s in order to further reduce the size of the intermetallic compounds in the aluminum substrate.

In order to meet this requirement, the plate finished by casting desirably has a thickness of 0.4 to 1.2 mm. In the following pages, a treatment method in the case of continuous casting is described in detail.

(Melting Step)

The aluminum melt prepared by first melting aluminum metal containing preferably at least 95 wt % of aluminum in a melting furnace and adding thereto preferably 0.03 to 0.50 wt % of iron, preferably 0.03 to 0.20 wt % of silicon, preferably 1 to 400 ppm of copper and other desired elements.

(Filtration)

Filtration of the melt is usually carried out by passing the melt through a filter such as a ceramic tube filter or a ceramic foam filter. The filtration is described in, for example, JP 6-57432 A, JP 3-162530 A, JP 5-140659 A, JP 4-231425 A, JP 4-276031 A, JP 5-311261 A, and JP 6-136466 A.

(Cleaning Treatment Step)

The aluminum melt that has been adjusted to a desired composition can be optionally subjected to cleaning treatment. Exemplary cleaning treatments that may be used to remove unnecessary gases such as hydrogen in the aluminum melt include flux treatment and degassing treatment using, for example, argon gas or chlorine gas. Cleaning treatment may be carried out by an ordinary method.

Cleaning treatment is not essential and is preferably carried out to prevent defects due to foreign matter such as nonmetallic inclusions and oxides in the aluminum melt, and defects due to dissolved gases in the aluminum melt.

Cleaning treatment is usually carried out by a process similar to flotation which involves blowing an inert gas such as argon into the melt by a rotor so that hydrogen gas within the melt is trapped in argon bubbles and raised to the melt surface, or by flux treatment. The degassing is described in, for example, JP 5-51659 A and JP 5-49148 U.

(Grain Refining Step)

The aluminum melt may contain grain refining elements. More specifically, a TiB₂-containing master alloy is preferably added to the aluminum melt as the grain refining material. This is because the addition of the grain refining material facilitates the grain refinement during continuous casting.

An exemplary TiB₂-containing master alloy that may be used includes a master alloy in wire form containing titanium (5%) and boron (1%) with the balance being aluminum and inevitable impurities. When used alone, TiB₂ particles usually have an extremely small particle size of 1 to 2 μm but may aggregate into coarse particles with sizes of 100 μm or more. In such a case, the coarse particles may cause unevenness in the surface treatments and therefore an agitation means is preferably provided in the channel.

(Filtering Step)

The aluminum melt is preferably filtered through a filter to remove impurities incorporated in the melt and contaminants remaining in the melting furnace and melt channel. The filtering step is also necessary to suppress flowing out of TiB₂ aggregate particles that can be added as desired, and a filtering bath is desirably provided downstream from the position at which TiB₂ as the grain refining material is added.

The filtering step and the filtering bath for use therein are preferably those as described in JP 3549080B.

(Feeding Step)

In the manufacturing method, the aluminum melt after the filtering step is preferably fed from the filtering bath to the melt feed nozzle through the channel.

The agitation means provided in the recess formed in the bottom surface of the channel is preferably used to agitate the aluminum melt. This is because the TiB₂ coarse particles having filtered through in the filtering step are prevented from aggregating again in the region where the melt stagnates.

(Melt Feed Nozzle)

The aluminum melt discharged from the melt feed nozzle comes in contact with the surfaces of the cooling rollers, where solidification of the melt starts. A melt meniscus is formed during movement of the aluminum melt from the tip of the melt feed nozzle to the surfaces of the cooling rollers. Vibrations of the melt meniscus cause the points of contact of the melt meniscus with the cooling rollers to vibrate, as a result of which portions having different solidification histories are formed on the cooling roller surfaces and nonuniformity of the crystalline structure and segregation of trace elements are more likely to occur. Such a defect is also called “ripple mark”, which may readily cause unevenness in the surface treatments after the aluminum substrate has been subjected to cold rolling, intermediate annealing and finish cold rolling.

In terms of reduction of such ripple mark, the tip of the melt feed nozzle is preferably inclined so that at least the outer surface on the lower side of the tip forms an acute angle with the direction of discharge of the aluminum melt, whereby the aluminum melt is consistently released from one point. For example, the method described in JP 10-58094 A may be advantageously used.

It is preferable to reduce the distance between the tip of the nozzle and the surface of each cooling roller in order to reduce the amplitude during vibrations of the meniscus.

More specifically, in a preferred embodiment, of the members forming the melt feed nozzle, a top plate member which comes in contact with the aluminum melt from the upper side and a bottom plate member which comes in contact with the aluminum melt from the lower side are vertically movable and the upper and bottom plate members are pressed against the surfaces of the adjoining cooling rollers under pressure from the aluminum melt. For example, the embodiment described in JP 2000-117402 A can be advantageously used.

(Cooling Roller)

The cooling rollers are not subject to any particular limitation. For example, use may be made of known cooling rollers having an iron core/shell construction. When cooling rollers with a core-shell construction are used, the cooling ability at the surfaces of the cooling rollers can be increased by having cooling water flow through channels provided between the core and the shell. Moreover, the aluminum substrate can be set precisely to a desired thickness by further applying a pressure to the solidified aluminum.

The aluminum which has solidified at the cooling roller surface may have a tendency to stick to the cooling rollers in this state, making it difficult to continuously carry out stable casting. In addition, the aluminum stuck to the cooling rollers may slow the cooling of the surface of the rolled aluminum. Hence, in the practice of the invention, a parting agent is preferably applied to the surfaces of the cooling rollers. The parting agent is preferably one having an excellent heat resistance. Suitable examples include parting agents which contain carbon graphite. The method of application is not subject to any particular limitation. A suitable example is a method in which a suspension of carbon graphite particles (preferably an aqueous suspension) is sprayed on. Spraying is preferred because the parting agent can be supplied to the cooling rollers without direct contact with the cooling rollers.

Because the parting agent becomes trapped by the wiper or other thickness uniformizing means or moves to the surface of the continuously cast aluminum substrate, it is desirable to periodically supply fresh parting agent to the surfaces of the cooling rollers.

The ingot obtained by DC casting has a thickness as large as tens of centimeters and therefore the thickness is preferably reduced by carrying out soaking step and hot rolling step before the subsequent cold rolling step. The procedures of the soaking step and the hot rolling step are described in paragraphs [0044] to [0046] of JP 2010-058315 A.

[Cold Rolling Step]

The casting step is followed by the cold rolling step. The cold rolling step is a step for reducing the thickness of the aluminum substrate obtained in the casting step. The aluminum substrate is thus rolled to a desired thickness.

The cold rolling step may be carried out by any method known in the art. More specifically, use may be made of the methods described in JP 6-220593 A, JP 6-210308 A, JP 7-54111 A, and JP 8-92709 A.

[Intermediate Annealing Step]

The cold rolling step is followed by the intermediate annealing step.

Hence, when the intermediate annealing step is carried out after the buildup of strain in the above-described cold rolling step, the dislocations are released, recrystallization occurs, and the crystal grains can be refined even further. Specifically, the crystal grains can be controlled by the reduction ratio in the cold rolling step and the heat treatment conditions (especially temperature, time and temperature rise rate) in the intermediate annealing step. For example, in continuous annealing, the aluminum substrate is generally heated at 300 to 600° C. for up to 10 minutes, preferably at 400 to 600° C. for up to 6 minutes, and more preferably at 450 to 550° C. for up to 2 minutes. Moreover, the temperature rise rate is generally set to about 0.5 to 500° C./min, although the formation of smaller crystal grains can be promoted by setting the temperature rise rate to 10 to 200° C./s and by shortening the holding time following temperature rise to at most 10 minutes, and preferably 2 minutes or less.

Batch annealing may be used but continuous annealing is desirably used because impurities such as iron and silicon may be discharged toward the crystal grain boundaries during the process from the temperature increase to the cooling thereby forming deposited particles.

The intermediate annealing step may be carried out by any method known in the art. More specifically, use may be made of the methods described in JP 6-220593 A, JP 6-210308 A, JP 7-54111 A, and JP 8-92709 A.

<Finish Cold Rolling Step>

The intermediate annealing step is followed by the finish cold rolling step, which is a step for reducing the thickness of the aluminum substrate after the intermediate annealing step. The aluminum substrate having undergone the finish cold rolling step preferably has a thickness of 0.1 to 0.5 mm.

The finish cold rolling step may be carried out by any method known in the art. The finish cold rolling step may be carried out in the same way as the cold rolling step preceding the foregoing intermediate annealing step.

(Flatness Correction Step)

The finish cold rolling step is preferably preceded by the flatness correction step. The flatness correction step is a step for correcting the flatness of the aluminum substrate.

The flatness correction step may be carried out by any method known in the art. For example, this step may be carried out by using a leveling machine such as a roller leveler or a tension leveler.

The flatness correction step may be carried out after the aluminum substrate has been cut into discrete sheets. However, to enhance productivity, it is preferable to correct the flatness of the aluminum substrate in the state of a continuous coil.

The finish-rolled plate desirably has a smooth surface and preferably has an arithmetic surface roughness Ra of up to 0.3 μm and more preferably up to 0.2 μm. The strength is preferably at least 60 MPa in terms of ease of handling.

<Conductive Path>

The conductive paths making up the anisotropically conductive member of the invention is made of a conductive material filled into the through micropores in the insulating base.

The conductive material is not particularly limited as long as it has electric conductivity. A material having an electric resistivity of up to 10³Ω·cm is preferred. Illustrative examples of the material that may be preferably used include metals such as gold (Au), silver (Ag), copper (Cu), aluminum (Al), magnesium (Mg), nickel (Ni) and indium-doped tin oxide (ITO).

Of these, in terms of electric conductivity, copper, gold, aluminum and nickel are preferred, and nickel, copper and gold are more preferred.

In terms of cost, it is more preferred to use gold for only forming the surfaces of the conductive paths exposed at or protruding from both the surfaces of the insulating base (hereinafter also referred to as “end faces”).

In the practice of the invention, the conductive paths are columnar and have a diameter (as shown by reference symbol 8 in FIG. 1B) of preferably 5 to 500 nm, more preferably 20 to 400 nm, and most preferably 30 to 200 nm. At a diameter of the conductive paths within the foregoing range, when electric signals are passed through the conductive paths, sufficient responses can be obtained, thus enabling more preferable use of the anisotropically conductive member of the invention as an electrically connecting member or an inspection connector for electronic components.

As described above, the ratio of the centerline length of each conductive path to the thickness of the insulating base (length/thickness) is preferably from 1.0 to 1.2 and more preferably from 1.0 to 1.05. A ratio of the centerline length of each conductive path to the thickness of the insulating base within the above-defined range enables the conductive path to be regarded as having a straight-tubular structure and ensures a one-to-one response when an electric signal is passed through. Therefore, the anisotropically conductive member of the invention may be more advantageously used as an inspection connector or electrically connecting member for electronic components.

In the practice of the invention, when both the ends of the conductive path protrude from both the surfaces of the insulating base, the protrusions (in FIG. 1B, the portions represented by reference symbols 4a and 4b; also referred to below as “bumps”) have a height of preferably from 10 to 100 nm, and more preferably from 10 to 50 nm. At a bump height in this range, connectivity with the electrode (pad) portion on an electronic component improves.

In the practice of the invention, the conductive paths are mutually insulated by the insulating base and are preferably formed at a density of at least 1×10⁷ pcs/mm², more preferably at least 5×10⁷ pcs/mm² and even more preferably at least 1×10⁸ pcs/mm². The density is not particularly limited for the upper limit but is preferably up to 1×10¹⁰ pcs/mm² in terms of the insulation between the neighboring conductive paths.

At a density of the conductive paths within the foregoing range, the anisotropically conductive member of the invention can be used as an inspection connector or an electrically connecting member for electronic components such as semiconductor devices even today when still higher levels of integration have been achieved.

The conductive path density is measured as follows: A surface of the anisotropically conductive member is observed by FE-SEM (S-4800 manufactured by Hitachi High-Technologies Corporation) at an observation magnification of 10,000× in a plurality of fields of view with a measured area of 0.01 mm². The number of conductive paths is counted based on the observation results to obtain the density.

In the practice of the invention, the center-to-center distance between neighboring conductive paths (the portion represented by reference symbol 9 in FIG. 1B; also referred to below as “pitch”) is preferably from 20 to 500 nm, more preferably from 40 to 200 nm, and even more preferably from 50 to 140 nm. At a pitch within the above-defined range, a balance is easily struck between the diameter of the conductive paths and the width between the conductive paths (insulating barrier thickness).

In the practice of the invention, the conductive paths can be formed by filling a conductive material (particularly a metal) into the through micropores in the insulating base.

The conductive material filling treatment step will be described in detail in connection with the anisotropically conductive member-manufacturing method of the invention to be referred to later.

The anisotropically conductive member of the invention preferably has an insulating base thickness of 1 to 1,000 μm and more preferably 30 to 300 μm, and a conductive path diameter of 5 to 500 nm, more preferably 20 to 400 nm and most preferably 30 to 200 nm, because electrical continuity can be confirmed at a high density while maintaining high insulating properties.

[Method of Manufacturing Anisotropically Conductive Member]

The method of manufacturing the anisotropically conductive member of the invention (hereinafter also referred to simply as the “manufacturing method of the invention”) is not particularly limited but preferably includes the following steps:

(Anodizing treatment step) Step in which an aluminum substrate is anodized;
(Perforating treatment step) Step in which micropores formed by anodization are perforated after the anodizing treatment step to obtain an insulating base; and
(Filling step) Step in which a conductive material is filled into through micropores in the resulting insulating base after the perforating treatment step to obtain the anisotropically conductive member.

The procedure of each step is described in detail below.

[Anodizing Treatment Step]

The anodizing treatment step is a step for anodizing the aluminum substrate to form a micropore-bearing oxide film at the surface of the aluminum substrate.

As described above, the aluminum substrate used in this step contains intermetallic compounds with predetermined sizes at a predetermined density. The surface of the aluminum substrate to be subjected to the anodizing treatment step is preferably subjected beforehand to degreasing treatment and mirror-like finishing treatment.

(Heat Treatment)

Heat treatment is preferably carried out at a temperature of from 200 to 350° C. for a period of about 30 seconds to about 2 minutes. Such heat treatment improves the orderliness of the array of micropores formed in the film by anodizing treatment.

Following heat treatment, it is preferable to rapidly cool the aluminum substrate. The method of cooling is exemplified by a method involving direct immersion of the aluminum substrate in water or the like.

### (Degreasing Treatment)

Degreasing treatment is carried out with a suitable substance such as an acid, alkali or organic solvent so as to dissolve and remove organic substances, including dust, grease and resins, adhering to the aluminum substrate surface, and thereby prevent defects due to organic substances from arising in each of the subsequent treatments.

Known degreasers may be used in degreasing treatment. For example, degreasing treatment may be carried out using any of various commercially available degreasers by the prescribed method.

(Mirror-Like Finishing Treatment)

Mirror-like finishing treatment is carried out to eliminate surface topographic features of the aluminum substrate to form the micropores of the anodized film in a more straight tubular shape. Exemplary surface topographic features of the aluminum substrate include rolling streaks formed during rolling of the aluminum substrate which requires a rolling step for its manufacture.

In the practice of the invention, mirror-like finishing treatment is not subject to any particular limitation, and may be carried out using any suitable method known in the art. Examples of suitable methods include mechanical polishing, chemical polishing, and electrolytic polishing.

These specific methods are described in detail in paragraphs [0042] to [0045] of JP 2010-177171 A.

Mirror-like finishing treatment enables a surface having, for example, an arithmetic mean roughness Ra of 0.1 μm or less and a glossiness of at least 50% to be obtained. The arithmetic mean roughness Ra is preferably up to 0.05 μm and more preferably up to 0.02 μm. The glossiness is preferably at least 70%, and more preferably at least 80%.

The glossiness is the specular reflectance which can be determined in accordance with JIS Z8741-1997 (Method 3: 60° Specular Gloss) in a direction perpendicular to the rolling direction. Specifically, measurement is carried out using a variable-angle glossmeter (e.g., VG-1D, manufactured by Nippon Denshoku Industries Co., Ltd.) at an angle of incidence/reflection of 60° when the specular reflectance is 70% or less, and at an angle of incidence/reflection of 20° when the specular reflectance is more than 70%.

Conventionally known methods may be used for anodizing treatment, but a self-ordering method and a constant voltage treatment to be described below are preferably used because the insulating base is preferably an anodized film obtained from an aluminum substrate, the anodized film having through micropores arrayed so as to have a degree of ordering as defined by formula (i) of at least 50%.

The self-ordering method is a method which enhances the orderliness by using the regularly arranging nature of micropores in an anodized film obtained by anodizing treatment and eliminating factors that may disturb an orderly arrangement. Specifically, an anodized film is formed on high-purity aluminum at a voltage appropriate for the type of electrolytic solution and at a low speed over an extended period of time (e.g., from several hours to well over ten hours).

In this method, because the micropore size (pore size) depends on the voltage, a desired pore size can be obtained to some extent by controlling the voltage.

In order to form micropores by the self-ordering method, at least the subsequently described anodizing treatment (A) should be carried out. However, micropore formation is preferably carried out by a process in which the subsequently described anodizing treatment (A), film removal treatment (B) and re-anodizing treatment (C) are carried out in this order (self-ordering method I), or a process in which the subsequently described anodizing treatment (D) and oxide film dissolution treatment (E) are carried out in this order at least once (self-ordering method II).

Next, the respective treatments in the self-ordering method I and self-ordering method II in the preferred embodiments are described in detail.

[Self-Ordering Method I]

### [Anodizing Treatment (A)]

The average flow velocity of electrolytic solution in anodizing treatment (A) is preferably from 0.5 to 20.0 m/min, more preferably from 1.0 to 15.0 m/min, and even more preferably from 2.0 to 10.0 m/min. By carrying out anodizing treatment (A) at the foregoing flow velocity, the anodized film may have micropores with a uniform and high degree of ordering.

The method for causing the electrolytic solution to flow under the above conditions is not subject to any particular limitation. For example, a method involving the use of a common agitator such as a stirrer may be employed. The use of a stirrer in which the stirring speed can be controlled with a digital display is particularly desirable because it enables the average flow velocity to be regulated. An example of such a stirrer is the Magnetic Stirrer HS-50D (manufactured by As One Corporation).

Anodizing treatment (A) may be carried out by, for example, a method in which current is passed through the aluminum substrate as the anode in a solution having an acid concentration of from 1 to 10 wt %.

The solution used in anodizing treatment (A) is preferably an acid solution. A solution of sulfuric acid, phosphoric acid, chromic acid, oxalic acid, sulfamic acid, benzenesulfonic acid, amidosulfonic acid, glycolic acid, tartaric acid, malic acid or citric acid is more preferred. Of these, a solution of sulfuric acid, phosphoric acid, or oxalic acid is especially preferred. These acids may be used singly or in combination of two or more thereof.

The anodizing treatment (A) conditions vary depending on the electrolytic solution employed, and thus cannot be strictly specified. However, the following conditions are generally preferred: an electrolyte concentration of from 0.1 to 20 wt %, a solution temperature of from −10 to 30° C., a current density of from 0.01 to 20 A/dm², a voltage of from 3 to 300 V, and an electrolysis time of from 0.5 to 30 hours. An electrolyte concentration of from 0.5 to 15 wt %, a solution temperature of from −5 to 25° C., a current density of from 0.05 to 15 A/dm², a voltage of from 5 to 250 V, and an electrolysis time of from 1 to 25 hours are more preferred. An electrolyte concentration of from 1 to 10 wt %, a solution temperature of from 0 to 20° C., a current density of from 0.1 to 10 A/dm², a voltage of from 10 to 200 V, and an electrolysis time of from 2 to 20 hours are even more preferred.

The treatment time in anodizing treatment (A) is preferably from 0.5 minute to 16 hours, more preferably from 1 minute to 12 hours, and even more preferably from 2 minutes to 8 hours.

Aside from being carried out at a constant voltage, anodizing treatment (A) may be carried out using a method in which the voltage is intermittently or continuously varied. In such cases, it is preferable to have the voltage gradually decrease. It is possible in this way to lower the resistance of the anodized film, bringing about the formation of small micropores in the anodized film. As a result, this approach is preferable for improving uniformity, particularly when sealing is subsequently carried out by electrodeposition treatment.

In the practice of the invention, the anodized film formed by such anodizing treatment (A) preferably has a thickness of 1 to 1,000 μm, more preferably 5 to 500 μm, and even more preferably 10 to 300 μm.

In the practice of the invention, the anodized film formed by such anodizing treatment (A) has an average micropore density of preferably from 50 to 1,500 pcs/μm².

It is preferable for the micropores to have a surface coverage of from 20 to 50%.

The surface coverage of the micropores is defined here as the ratio of the total surface area of the micropore openings to the surface area of the aluminum surface.

[Film Removal Treatment (B)]

In film removal treatment (B), the anodized film formed at the surface of the aluminum substrate by the above-described anodizing treatment (A) is dissolved and removed.

The subsequently described perforating treatment step may be carried out immediately after forming an anodized film at the surface of the aluminum substrate by the above-described anodizing treatment (A). However, it is preferred to additionally carry out after the above-described anodizing treatment (A), film removal treatment (B) and the subsequently described re-anodizing treatment (C) in this order, followed by the subsequently described perforating treatment step.

Given that the orderliness of the anodized film increases as the aluminum substrate is approached, by using this film removal treatment (B) to remove the anodized film that has been formed, the lower portion of the anodized film remaining at the surface of the aluminum substrate emerges at the surface, affording an orderly array of pits. Therefore, in film removal treatment (B), aluminum is not dissolved; only the anodized film made of alumina (aluminum oxide) is dissolved.

The alumina dissolving solution is preferably an aqueous solution containing at least one substance selected from the group consisting of chromium compounds, nitric acid, phosphoric acid, zirconium compounds, titanium compounds, lithium salts, cerium salts, magnesium salts, sodium hexafluorosilicate, zinc fluoride, manganese compounds, molybdenum compounds, magnesium compounds, barium compounds, and uncombined halogens.

Illustrative examples of chromium compounds include chromium (III) oxide and chromium (VI) oxide.

Examples of zirconium compounds include zirconium ammonium fluoride, zirconium fluoride and zirconium chloride.

Examples of titanium compounds include titanium oxide and titanium sulfide.

Examples of lithium salts include lithium fluoride and lithium chloride.

Examples of cerium salts include cerium fluoride and cerium chloride.

Examples of magnesium salts include magnesium sulfide.

Examples of manganese compounds include sodium permanganate and calcium permanganate.

Examples of molybdenum compounds include sodium molybdate.

Examples of magnesium compounds include magnesium fluoride pentahydrate.

Examples of barium compounds include barium oxide, barium acetate, barium carbonate, barium chlorate, barium chloride, barium fluoride, barium iodide, barium lactate, barium oxalate, barium perchlorate, barium selenate, barium selenite, barium stearate, barium sulfite, barium titanate, barium hydroxide, barium nitrate, and hydrates thereof.

Of the above barium compounds, barium oxide, barium acetate and barium carbonate are preferred. Barium oxide is especially preferred.

Examples of uncombined halogens include chlorine, fluorine and bromine.

Of the above, the alumina dissolving solution is preferably an acid-containing aqueous solution. Examples of the acid include sulfuric acid, phosphoric acid, nitric acid and hydrochloric acid. A mixture of two or more acids is also acceptable.

The acid concentration is preferably at least 0.01 mol/L, more preferably at least 0.05 mol/L and even more preferably at least 0.1 mol/L. Although there is no particular upper limit in the acid concentration, in general, the concentration is preferably 10 mol/L or less, and more preferably 5 mol/L or less. A needlessly high concentration is uneconomical and may result in dissolution of the aluminum substrate.

The alumina dissolving solution has a temperature of preferably −10° C. or higher, more preferably −5° C. or higher, and even more preferably 0° C. or higher. Carrying out treatment using a boiling alumina dissolving solution destroys or disrupts the starting points for ordering. Hence, the alumina dissolving solution is preferably used without being boiled.

The alumina dissolving solution dissolves alumina, but does not dissolve aluminum. Here, the alumina dissolving solution may dissolve a very small amount of aluminum, so long as it does not dissolve a substantial amount of aluminum.

Film removal treatment (B) is carried out by bringing an aluminum substrate at which an anodized film has been formed into contact with the above-described alumina dissolving solution. Examples of the contacting method include, but are not limited to, immersion and spraying. Of these, immersion is preferred.

Immersion is a treatment in which the aluminum substrate at which an anodized film has been formed is immersed in the alumina dissolving solution. To achieve uniform treatment, it is desirable to carry out stirring at the time of immersion treatment.

The immersion treatment time is preferably at least 10 minutes, more preferably at least 1 hour, even more preferably at least 3 hours, and most preferably at least 5 hours.

[Re-Anodizing Treatment (C)]

An anodized film having micropores with an even higher degree of ordering can be formed by carrying out anodizing treatment once again after the anodized film is removed by the above-described film removal treatment (B) to form well-ordered pits at the surface of the aluminum substrate.

Re-anodizing treatment (C) may be carried out using a method known in the art, although it is preferably carried out under the same conditions as the above-described anodizing treatment (A).

Alternatively, suitable use may be made of a method in which the current is repeatedly turned on and off while keeping the dc voltage constant, or a method in which the current is repeatedly turned on and off while intermittently varying the dc voltage. Because these methods result in the formation of small micropores in the anodized film, they are preferable for improving uniformity, particularly when sealing is to be carried out by electrodeposition treatment.

When re-anodizing treatment (C) is carried out at a low temperature, the array of micropores is well-ordered and the pore size is uniform.

On the other hand, by carrying out re-anodizing treatment (C) at a relatively high temperature, the micropore array may be disrupted or the variations in pore size may be adjusted within a given range. The variations in pore size may also be controlled by the treatment time.

In the invention, the anodized film formed by such re-anodizing treatment (C) has a thickness of preferably from 30 to 1,000 μm, and more preferably from 50 to 500 μm.

In the invention, the anodized film formed by such anodizing treatment (C) has micropores with a pore size of preferably from 0.01 to 0.5 μm, and more preferably from 0.02 to 0.1 μm.

The average micropore density is preferably at least 1×10⁷ pcs/mm².

In the self-ordering method I, in place of the above-described anodizing treatment (A) and film removal treatment (B), use may be made of, for example, a physical process, a particle beam process, a block copolymer process or a resist patterning/exposure/etching process to form pits as starting points for micropore formation by the above-described re-anodizing treatment (C).

These methods are described in detail in paragraphs [0079] to [0082] of JP 2008-270158 A.

[Self-Ordering Method II]

### [First Step: Anodizing Treatment (D)]

Conventionally known electrolytic solutions may be used in anodizing treatment (D) but the orderliness of the pore array can be considerably improved by carrying out, under conditions of direct current and constant voltage, anodization using an electrolytic solution in which the parameter R represented by general formula (II) wherein A is the film-forming rate during application of current and B is the film dissolution rate during non-application of current satisfies 160≦R≦200, preferably 170≦R≦190 and most particularly 175≦R≦185.

R=A[nm/s]/(B[nm/s]×voltage applied [V]) (ii)

As in the above-described anodizing treatment (A), the average flow velocity of electrolytic solution in anodizing treatment (D) is preferably from 0.5 to 20.0 m/min, more preferably from 1.0 to 15.0 m/min, and even more preferably from 2.0 to 10.0 m/min. By carrying out anodizing treatment (D) at the flow velocity within the above-defined range, the anodized film may have micropores with a uniform and high degree of ordering.

As in the above-described anodizing treatment (A), the method for causing the electrolytic solution to flow under the above conditions is not subject to any particular limitation. For example, a method involving the use of a common agitator such as a stirrer may be employed.

The anodizing treatment solution preferably has a viscosity at 25° C. and 1 atm of 0.0001 to 100.0 Pa·s and more preferably 0.0005 to 80.0 Pa·s. By carrying out anodizing treatment (D) using the electrolytic solution having the viscosity within the above-defined range, a uniform and high degree of ordering can be achieved.

The electrolytic solution used in anodizing treatment (D) may be an acidic solution or an alkaline solution, but an acidic electrolytic solution is advantageously used in terms of improving the circularity of the through micropores.

More specifically, as in the above-described anodizing treatment (A), a solution of hydrochloric acid, sulfuric acid, phosphoric acid, chromic acid, oxalic acid, glycolic acid, tartaric acid, malic acid, citric acid, sulfamic acid, benzenesulfonic acid or amidosulfonic acid is more preferred. Of these, a solution of sulfuric acid, phosphoric acid or oxalic acid is especially preferred. These acids may be used singly or in combination of two or more thereof by adjusting as desired the parameter in the calculating formula represented by general formula (ii).

The anodizing treatment (D) conditions vary depending on the electrolytic solution employed, and thus cannot be strictly specified. However, as in the above-described anodizing treatment (A), the following conditions are generally preferred: an electrolyte concentration of from 0.1 to 20 wt %, a solution temperature of from −10 to 30° C., a current density of from 0.01 to 20 A/dm², a voltage of from 3 to 500 V, and an electrolysis time of from 0.5 to 30 hours. An electrolyte concentration of from 0.5 to 15 wt %, a solution temperature of from −5 to 25° C., a current density of from 0.05 to 15 A/dm², a voltage of from 5 to 250 V, and an electrolysis time of from 1 to 25 hours are more preferred. An electrolyte concentration of from 1 to 10 wt %, a solution temperature of from 0 to 20° C., a current density of from 0.1 to 10 A/dm², a voltage of from 10 to 200 V, and an electrolysis time of from 2 to 20 hours are even more preferred.

In the practice of the invention, the anodized film formed by such anodizing treatment (D) preferably has a thickness of 0.1 to 300 μm, more preferably 0.5 to 150 μm, and even more preferably 1 to 100 μm.

In the invention, the anodized film formed by such anodizing treatment (D) has an average micropore density of preferably from 50 to 1,500 pcs/μm².

It is preferable for the micropores to have a surface coverage of from 20 to 50%.

The surface coverage of the micropores is defined here as the ratio of the total surface area of the micropore openings to the surface area of the aluminum surface.

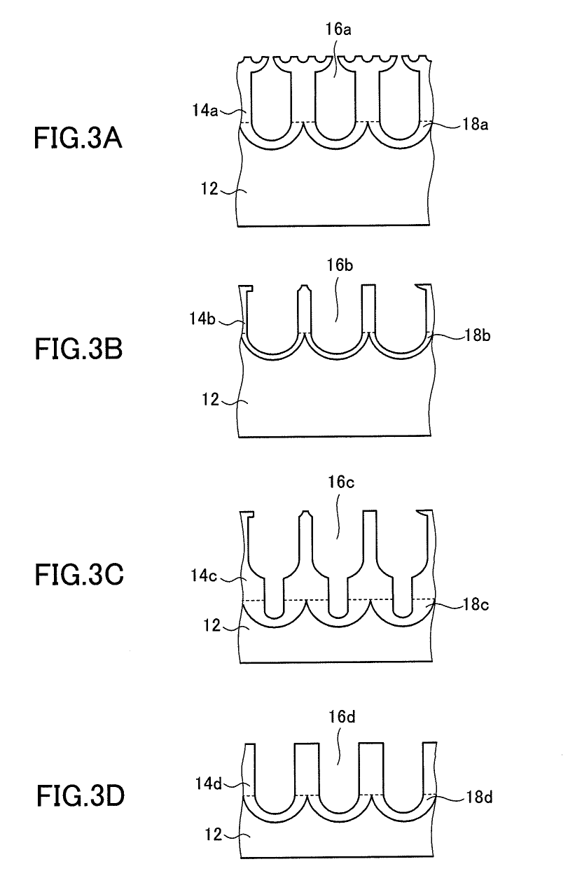

As shown in FIG. 3A, as a result of anodizing treatment (D), an anodized film 14a bearing micropores 16a is formed at a surface of an aluminum substrate 12. A barrier layer 18a is present on the side of the anodized film 14a closer to the aluminum substrate 12.

[Second Step: Oxide Film Dissolution Treatment (E)]

Oxide film dissolution treatment (E) is a treatment for enlarging the diameter of the micropores present in the anodized film formed by the above-described anodizing treatment (D) (pore size enlarging treatment).

Oxide film dissolution treatment (E) is carried out by bringing the aluminum substrate having undergone the above-described anodizing treatment (D) into contact with an aqueous acid or alkali solution. Examples of the contacting method include, but are not limited to, immersion and spraying. Of these, immersion is preferred.

When oxide film dissolution treatment (E) is to be carried out with an aqueous acid solution, it is preferable to use an aqueous solution of an inorganic acid such as sulfuric acid, phosphoric acid, nitric acid or hydrochloric acid, or a mixture thereof. It is particularly preferable to use an aqueous solution containing no chromic acid in terms of its high degree of safety. The aqueous acid solution preferably has a concentration of 1 to 10 wt %. The aqueous acid solution preferably has a temperature of 25 to 60° C.

When oxide film dissolution treatment (E) is to be carried out with an aqueous alkali solution, it is preferable to use an aqueous solution of at least one alkali selected from the group consisting of sodium hydroxide, potassium hydroxide and lithium hydroxide. The aqueous alkali solution preferably has a concentration of 0.1 to 5 wt %. The aqueous alkali solution preferably has a temperature of 20 to 35° C.

Specific examples of solutions that may be preferably used include a 40° C. aqueous solution containing 50 g/L of phosphoric acid, a 30° C. aqueous solution containing 0.5 g/L of sodium hydroxide, and a 30° C. aqueous solution containing 0.5 g/L of potassium hydroxide.

The time of immersion in the aqueous acid solution or aqueous alkali solution is preferably from 8 to 120 minutes, more preferably from 10 to 90 minutes and even more preferably from 15 to 60 minutes.

In oxide film dissolution treatment (E), the degree of enlargement of the pore size varies with the conditions of anodizing treatment (D) but the ratio of the pore size after the treatment to that before the treatment is preferably 1.05 to 100, more preferably 1.1 to 75 and most preferably 1.2 to 50.

Oxide film dissolution treatment (E) dissolves the surface of the anodized film 14a and the interiors of the micropores 16a (barrier layer 18a and the porous layer) as shown in FIG. 3A to obtain an aluminum member having a micropore 16b-bearing anodized film 14b on the aluminum substrate 12 as shown in FIG. 3B. As in FIG. 3A, a barrier layer 18b is present on the side of the anodized film 14b closer to the aluminum substrate 12.

[Third Step: Anodizing Treatment (D)]

In the self-ordering method II, it is preferred to carry out the above-described anodizing treatment (D) again after the above-described oxide film dissolution treatment (E).

By carrying out anodizing treatment (D) again, oxidation reaction of the aluminum substrate 12 shown in FIG. 3B proceeds to obtain, as shown in FIG. 3C, an aluminum member which has an anodized film 14c formed on the aluminum substrate 12, the anodized film 14c bearing micropores 16c having a larger depth than the micropores 16b. As in FIG. 3A, a barrier layer 18c is present on the side of the anodized film 14c closer to the aluminum substrate 12.

[Fourth Step: Oxide Film Dissolution Treatment (E)]

In the self-ordering method II, it is preferred to further carry out the above-described oxide film dissolution treatment (E) after the above-described anodizing treatment (D), oxide film dissolution treatment (E) and anodizing treatment (D) have been carried out in this order.

This treatment enables the treatment solution to enter the micropores to dissolve the anodized film formed by anodizing treatment (D) in the third step, whereby the micropores formed by anodizing treatment (D) in the third step may have enlarged diameters.

More specifically, oxide film dissolution treatment (E) carried out again dissolves the interiors of the micropores 16c on the surface side from inflection points in the anodized film 14c shown in FIG. 3C to obtain an aluminum member having an anodized film 14d bearing straight tube-shaped micropores 16d on the aluminum substrate 12 as shown in FIG. 3D. As in FIG. 3A, a barrier layer 18d is present on the side of the anodized film 14d closer to the aluminum substrate 12.

The degree of enlargement of the pore size varies with the conditions of anodizing treatment (D) carried out in the third step but the ratio of the pore size after the treatment to that before the treatment is preferably 1.05 to 100, more preferably 1.1 to 75 and even more preferably 1.2 to 50.

The self-ordering method II involves at least one cycle of the above-described anodizing treatment (D) and oxide film dissolution treatment (E). The larger the number of repetitions is, the higher the degree of ordering of the pore array is.

The circularity of the micropores seen from the film surface side is dramatically improved by dissolving in oxide film dissolution treatment (E) the anodized film formed by the preceding anodizing treatment (D). Therefore, this cycle is preferably repeated at least twice, more preferably at least three times and even more preferably at least four times.

In cases where this cycle is repeated at least twice, the conditions in each cycle of oxide film dissolution treatment and anodizing treatment may be the same or different. Alternatively, the treatment may be terminated by anodizing treatment.

[Perforating Treatment Step]

The perforating treatment step is a step in which micropores formed by anodization are perforated after the anodizing treatment step to obtain an insulating base having through micropores.

More specifically, the perforating treatment step is carried out by, for example, a method in which the aluminum substrate (the portion represented by reference symbol 12 in FIG. 3D) is dissolved after the anodizing treatment step and the bottom (the portion represented by reference symbol 18d in FIG. 3D) of the anodized film is removed, and a method in which the aluminum substrate and the anodized film in the vicinity of the aluminum substrate are cut after the anodizing treatment step.

Next, the former method which is a preferred embodiment is described in detail.

(Dissolution of Aluminum Substrate)

A treatment solution which does not readily dissolve the anodized film (alumina) but readily dissolves aluminum is used for dissolution of the aluminum substrate after the anodizing treatment step.

That is, use is made of a treatment solution which has an aluminum dissolution rate of at least 1 μm/min, preferably at least 3 μm/min, and more preferably at least 5 μm/min, and has an anodized film dissolution rate of 0.1 nm/min or less, preferably 0.05 nm/min or less, and more preferably 0.01 nm/min or less.

Specifically, a treatment solution which includes at least one metal compound having a lower ionization tendency than aluminum, and which has a pH of 4 or less or 8 or more, preferably 3 or less or 9 or more, and more preferably 2 or less or 10 or more is used for immersion treatment.

Preferred examples of such treatment solutions include solutions which are composed of, as the base, an aqueous solution of an acid or an alkali and which have blended therein a compound of, for example, manganese, zinc, chromium, iron, cadmium, cobalt, nickel, tin, lead, antimony, bismuth, copper, mercury, silver, palladium, platinum or gold (e.g., chloroplatinic acid), or a fluoride or chloride of any of these metals.

Of the above, it is preferable for the treatment solution to be based on an aqueous solution of an acid and to have blended therein a chloride compound.

Treatment solutions of an aqueous solution of hydrochloric acid in which mercury chloride has been blended (hydrochloric acid/mercury chloride), and treatment solutions of an aqueous solution of hydrochloric acid in which copper chloride has been blended (hydrochloric acid/copper chloride) are especially preferred from the standpoint of the treatment latitude.

There is no particular limitation on the composition of such treatment solutions. Illustrative examples of the treatment solutions that may be used include a bromine/methanol mixture, a bromine/ethanol mixture, and aqua regia.

Such a treatment solution preferably has an acid or alkali concentration of 0.01 to 10 mol/L and more preferably 0.05 to 5 mol/L.

In addition, such a treatment solution is used at a treatment temperature of preferably −10° C. to 80° C. and more preferably 0 to 60° C.

In the invention, dissolution of the aluminum substrate is carried out by bringing the aluminum substrate having undergone the anodizing treatment step into contact with the above-described treatment solution. Examples of the contacting method include, but are not limited to, immersion and spraying. Of these, immersion is preferred. The period of contact in this process is preferably from 10 seconds to 5 hours and more preferably from 1 minute to 3 hours.

(Removal of Bottom of Anodized Film)

The bottom of the anodized film after the dissolution of the aluminum substrate is removed by immersion in an aqueous acid or alkali solution. Removal of the bottom of the anodized film causes the micropores to extend therethrough.

The bottom of the anodized film is preferably removed by the method that involves previously immersing the anodized film in a pH buffer solution to fill the micropores with the pH buffer solution from the micropore opening side, and bringing the surface opposite from the openings (i.e., the bottom of the anodized film) into contact with an aqueous acid solution or aqueous alkali solution.

When this treatment is to be carried out with an aqueous acid solution, it is preferable to use an aqueous solution of an inorganic acid such as sulfuric acid, phosphoric acid, nitric acid or hydrochloric acid, or a mixture thereof. The aqueous acid solution preferably has a concentration of 1 to 10 wt %. The aqueous acid solution preferably has a temperature of 25 to 40° C.

When this treatment is to be carried out with an aqueous alkali solution, it is preferable to use an aqueous solution of at least one alkali selected from the group consisting of sodium hydroxide, potassium hydroxide and lithium hydroxide. The aqueous alkali solution preferably has a concentration of 0.1 to 5 wt %. The aqueous alkali solution preferably has a temperature of 20 to 35° C.

Specific examples of solutions that may be preferably used include a 40° C. aqueous solution containing 50 g/L of phosphoric acid, a 30° C. aqueous solution containing 0.5 g/L of sodium hydroxide, and a 30° C. aqueous solution containing 0.5 g/L of potassium hydroxide.

The time of immersion in the aqueous acid solution or aqueous alkali solution is preferably from 8 to 120 minutes, more preferably from 10 to 90 minutes and even more preferably from 15 to 60 minutes.

In cases where the film is previously immersed in a pH buffer solution, a buffer solution suitable to the foregoing acids/alkalis is used.

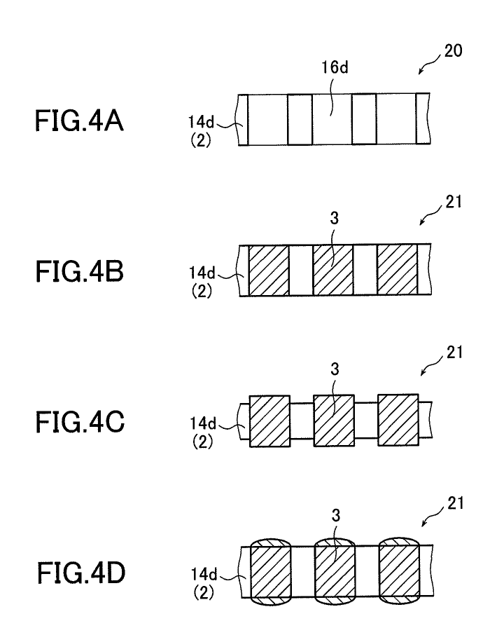

This perforating treatment step yields a structure shown in FIG. 3D after removal of the aluminum substrate 12 and the barrier layer 18d, that is, an insulating base 20 as shown in FIG. 4A.

On the other hand, an example of the latter method that may be advantageously used to cut the aluminum substrate and the anodized film in the vicinity of the aluminum substrate includes one which involves physically removing the aluminum substrate (portion represented by reference symbol 12 in FIG. 3D) and the bottom (portion represented by reference symbol 18d in FIG. 3D) of the anodized film by cutting with a laser beam or other various polishing treatments.

[Filling Step]

The filling step is a step in which a conductive material is filled into through micropores in the resulting insulating base after the perforating treatment step to obtain the anisotropically conductive member.

The conductive material to be filled makes up the conductive paths of the anisotropically conductive member and examples thereof are as described above.

In the manufacturing method of the invention, an electrolytic plating process or an electroless plating process may be used to fill the micropores with a metal as a conductive material.

Electrolytic plating is preferably preceded by electrode film-forming treatment to form an electrode film having no void on one surface of the insulating base.

The method of forming the electrode film is not particularly limited and preferred examples thereof include electroless plating of a metal and direct application of a conductive material such as a metal. Of these, electroless plating is more preferred in terms of the uniformity of the electrode film and the ease of operation. When electroless plating is used for electrode film-forming treatment, it is preferred to form plating nuclei on one surface of the oxide film. More specifically, a method is preferably used in which a metal or metal compound of the same type as a specific metal to be provided by electroless plating or a metal or metal compound having a higher ionization tendency than a specific metal to be provided by electroless plating is provided on one surface of the insulating base. Exemplary methods of providing such metal or metal compound include vapor deposition, sputtering and direct application, but the invention is not particularly limited to these methods.

After the plating nuclei have been provided as described above, the electrode film is formed by electroless plating. Immersion is a preferable treatment method from the viewpoint that the thickness of the electrode layer can be controlled by the time.

Any conventionally known type of electroless plating solution may be used.

Noble metal-containing plating solutions such as a gold plating solution, a copper plating solution and a silver plating solution are preferable in terms of increasing the electrical continuity of the electrode film to be formed, and a gold plating solution is more preferable in terms of the long-term stability of the electrode, that is, the prevention of the deterioration due to oxidation.

In the manufacturing method of the invention, when metal filling is carried out by the electrolytic plating process, it is preferred to provide rest periods during pulse electrolysis or constant potential electrolysis. The rest periods must be at least 10 seconds, and are preferably from 30 to 60 seconds.

To promote stirring of the electrolytic solution, it is desirable to apply ultrasound energy.

Moreover, the electrolysis voltage is generally not more than 20 V, and preferably not more than 10 V, although it is preferable to first measure the deposition potential of the target metal in the electrolytic solution to be used and carry out constant potential electrolysis at that potential+not more than 1V. When carrying out constant potential electrolysis, it is desirable to use also cyclic voltammetry. To this end, use may be made of potentiostats such as those available from Solartron, BAS Inc., Hokuto Denko Corporation and Ivium Technologies.

Any conventionally known plating solution may be used for metal filling.

More specifically, when copper is to be deposited, an aqueous solution of copper sulfate may generally be used. The concentration of copper sulfate is preferably from 1 to 300 g/L, and more preferably from 100 to 200 g/L. Deposition can be promoted by adding hydrochloric acid to the electrolytic solution. In such a case, the concentration of hydrochloric acid is preferably from 10 to 20 g/L.

When gold is to be deposited, it is desirable to carry out plating by alternating current electrolysis using a sulfuric acid solution of a tetrachloroaurate.

According to the electroless plating process, it takes much time to completely fill the micropores having a high aspect ratio with a metal and it is therefore desirable to fill the metal by the electrolytic plating process in the inventive manufacturing method.

This filling step yields an anisotropically conductive member 21 shown in FIG. 4B.

[Insulating Material Filling Treatment]

The filling step may be optionally followed by sealing treatment of the insulating base filled with the metal, and insulating material filling treatment may be performed to further fill the insulating base with the insulating material so that the ratio of formation of conductive paths may be 99% or more.

Sealing treatment in the insulating material filling treatment is not particularly limited and may be performed in accordance with a known process, such as boiling water treatment, hot water treatment, steam treatment, sodium silicate treatment, nitrite treatment or ammonium acetate treatment. For example, sealing treatment may be performed using the apparatuses and processes described in JP 56-12518 B, JP 4-4194 A, JP 5-202496 A and JP 5-179482 A.

When the ratio of formation of conductive paths using metal and an insulating material is within the foregoing range, an anisotropically conductive member capable of further suppressing interconnect failure can be provided.

Fine dust or oil (hereinafter collectively referred to as “contaminants”) derived from the material for forming an interconnect layer (mainly in liquid form) may remain in the unsealed through micropores during the formation of the interconnect layer on the anisotropically conductive member to deteriorate the adhesion to the interconnect layer. On the other hand, presence of such contaminants is suppressed by filling the through micropores with a predetermined insulating material so that the ratio of formation of conductive paths in the through micropores may be at least 99%.

[Surface Planarization Treatment]

In the manufacturing method of the invention, the filling step is preferably followed by a surface planarization step in which the top side and the back side are planarized by polishing (e.g., chemical mechanical polishing).

By carrying out chemical mechanical polishing (CMP), the top and back sides after metal filling are preferably planarized while removing excess metal adhering to the surfaces.

CMP treatment may be carried out using a CMP slurry such as PNANERLITE-7000 available from Fujimi Inc., GPX HSC800 available from Hitachi Chemical Co., Ltd., or CL-1000 available from AGC Seimi Chemical Co., Ltd.

It is not preferred to use a slurry for interlayer dielectric films and barrier metals, because the anodized film should not be polished.

[Trimming Treatment]

In the manufacturing method of the invention, the filling step or the surface planarization step is preferably followed by a trimming step.

The trimming step is a step in which only part of the insulating base in the surfaces of the anisotropically conductive member is removed after the filling step or the surface planarization step to protrude the conductive paths from the anisotropically conductive film surfaces.

Trimming treatment can be carried out under the same treatment conditions as those of the above-described oxide film dissolution treatment (E) if a material making up the conductive paths (e.g., metal) is not dissolved. It is particularly preferred to use phosphoric acid with which the dissolution rate is readily controlled.

The trimming step yields the anisotropically conductive member 21 shown in FIG. 4C.

[Electrodeposition Treatment]

In the manufacturing method of the invention, the trimming step may be replaced or followed by an electrodeposition step in which a conductive metal which is the same as or different from the one filled into the micropores is further deposited only on the surfaces of the conductive paths 3 shown in FIG. 4B (FIG. 4D).

In the practice of the invention, electrodeposition is a treatment which also includes electroless plating making use of differences in the electronegativity of dissimilar metals.

Electroless plating is a step in which the insulating base is immersed in an electroless plating solution (e.g., a solution obtained by appropriately mixing a reducing agent treatment solution having a pH of 6 to 13 with a noble metal-containing treatment solution having a pH of 1 to 9).

In the manufacturing method of the invention, the trimming step and the electrodeposition step are preferably carried out just before the use of the anisotropically conductive member. It is preferred to carry out these treatments just before the use because metal making up the bumps of the conductive paths does not oxidize until just before the use.

[Protective Film-Forming Treatment]

In the manufacturing method of the invention, the micropore size may change with time by the hydration of the insulating base made of alumina with moisture in the air and therefore protective film-forming treatment is preferably carried out before the filling step.

Illustrative examples of protective films include inorganic protective films containing elemental zirconium and/or elemental silicon, and organic protective films containing a water-insoluble polymer.

These are described in detail in paragraphs [0138] to of JP 2008-270157 A.

[Anisotropically Conductive Member]

The anisotropically conductive member of the invention may be used in various applications, for example, as an electric contact (electronically connecting member) between a CPU motherboard and an interposer or as an electric contact between an interposer and a CPU IC chip.

In terms of the application to the foregoing uses, the anisotropically conductive member of the invention preferably has a resistivity in the thickness direction of the conductive paths of 1×10⁻⁴ Ωm or less, more preferably 1×10⁻⁵ Ωm or less and even more preferably 1×10⁻⁷ Ωm or less.

### EXAMPLES

The invention is described below more specifically by way of examples. However, the invention should not be construed as being limited to the following examples.

### Examples 1 and 2

### (1) Mirror-Like Finishing Treatment

### Electrolytic Polishing

A high-purity aluminum substrate (Nippon Light Metal Co., Ltd.; purity, 99.9999 wt %; thickness, 0.4 mm) was cut to a size of 10 cm square that allows it to be anodized, then subjected to electrolytic polishing using an electrolytic polishing solution of the composition indicated below at a voltage of 25 V, a solution temperature of 65° C., and a solution flow velocity of 3.0 m/min.

A carbon electrode was used as the cathode, and a GP0110-30R unit (Takasago, Ltd.) was used as the power supply. In addition, the flow velocity of the electrolytic solution was measured using a vortex flow monitor FLM22-10PCW manufactured by As One Corporation.

(Composition of Electrolytic Polishing Solution)

| | | |
|---|---|---|
| 85 wt % Phosphoric acid | 660 | mL |
| (Wako Pure Chemical Industries, Ltd.) | | |
| Pure water | 160 | mL |
| Sulfuric acid | 150 | mL |
| Ethylene glycol | 30 | mL |

### (2) Anodizing Treatment

The aluminum substrate having undergone electrolytic polishing was subjected to self-ordering anodizing treatment according to the procedure described in JP 2007-204802 A.

To be more specific, the aluminum substrate having undergone electrolytic polishing was then subjected to 5 hours of preliminary anodizing treatment with an electrolytic solution of 0.50 mol/L oxalic acid under the following conditions: voltage, 40 V; solution temperature, 16° C.; and solution flow velocity, 3.0 m/min.

After preliminary anodizing treatment, the aluminum substrate was subjected to film removal treatment in which it was immersed for 12 hours in a mixed aqueous solution (solution temperature, 50° C.) of 0.2 mol/L chromic anhydride and 0.6 mol/L phosphoric acid.

Next, the aluminum substrate was subjected to 16 hours of re-anodizing treatment with an electrolytic solution of 0.50 mol/L oxalic acid under the following conditions: voltage, 40 V; solution temperature, 16° C.; and solution flow velocity, 3.0 m/min. An oxide film having a thickness of 130 μm was thus obtained.

Preliminary anodizing treatment and re-anodizing treatment were both carried out using a stainless steel electrode as the cathode and using a GP0110-30R unit (Takasago, Ltd.) as the power supply. Use was made of NeoCool BD36 (Yamato Scientific Co., Ltd.) as the cooling system, and Pairstirrer PS-100 (Tokyo Rikakikai Co., Ltd.) as the stirring and warming unit. In addition, the flow velocity of the electrolytic solution was measured using the vortex flow monitor FLM22-10PCW (As One Corporation).

### (3) Perforating Treatment

Next, the aluminum substrate was dissolved by 3 hours of immersion at 20° C. in a 20 wt % aqueous solution of mercuric chloride (corrosive sublimate). Then, the anodized film was immersed in 5 wt % phosphoric acid at 30° C. for 30 minutes to remove the bottom of the anodized film to thereby prepare an anodized film having through micropores.

The through micropores had an average pore size of 30 nm. The average pore size was determined by taking a surface image by FE-SEM at a magnification of 50,000×, measuring the pore size at 50 points and calculating the average of the measurements.

The through micropores had an average depth of 130 μm. The average depth was determined by cutting the resulting microstructure in the thickness direction of the through micropores with FIB, taking an image of the cross-sectional surface by FE-SEM at a magnification of 50,000×, measuring the micropore depth at 10 points and calculating the average of the measurements.

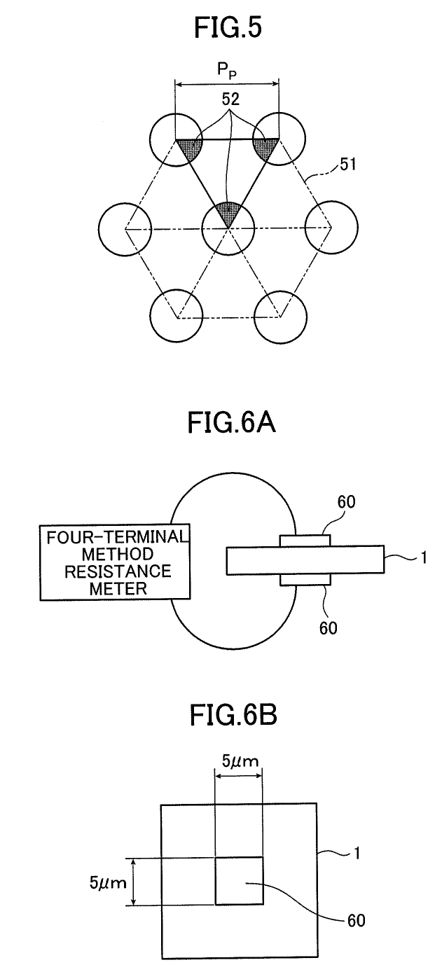

The density of the through micropores was about 1×10⁸ pcs/mm². The density was calculated by the following formula assuming that the unit cell 51 of through micropores arranged so that the order of ordering as defined by formula (i) described above was at least 50% contained a half of the through micropore 52 as shown in FIG. 5.

Density[pcs/μm²]=(½)/{Pp(μm)×Pp(μm)×√3×(½)}

where Pp is the pitch of the through micropores.

The degree of ordering of the through micropores was 92%. A surface image (magnification: 20,000×) was taken by FE-SEM, and the degree of ordering of the through micropores, as defined by above formula (i), was measured in a field of view of 2 μm×2 μm.

### (4) Heating Treatment

Then, the through micropore-bearing structure obtained as above was heated at a temperature of 400° C. for 1 hour.

### (5) Electrode Film-Forming Treatment

Next, a treatment was carried out for forming an electrode film on one surface of the through micropore-bearing structure having undergone the above-described heating treatment.

To be more specific, an aqueous solution of 0.7 g/L chloroauric acid was applied to one surface, dried at 140° C. for 1 minute and further baked at 500° C. for 1 hour to form plating nuclei of gold.

Then, PRECIOUSFAB ACG2000 base solution/reducing solution (available from Electroplating Engineers of Japan Ltd.) was used as the electroless plating solution to carry out immersion at 50° C. for 1 hour to thereby form the electrode film having no void.

### (6) Metal Filling Treatment Step

### Electrolytic Plating

Next, a copper electrode was placed in close contact with the surface of the formed electrode film, and electrolytic plating was carried out using the copper electrode as the cathode and platinum as the anode.

In Example 1, the copper plating solution of the composition indicated below was used to carry out constant current electrolysis to thereby prepare an anisotropically conductive member in which the through micropores were filled with copper. In Example 2, the nickel plating solution of the composition indicated below was used to carry out constant current electrolysis to thereby prepare an anisotropically conductive member in which the through micropores were filled with nickel.

After the deposition potential was checked by cyclic voltammetry in the plating solution, constant current electrolysis was carried out under the following conditions using an electroplating system manufactured by Yamamoto-MS Co., Ltd. and a power supply (HZ-3000) manufactured by Hokuto Denko Corp.

[Composition of Copper Plating Solution]

| | | |
|---|---|---|
| Copper sulfate | 100 | g/L |
| Sulfuric acid | 50 | g/L |
| Hydrochloric acid | 15 | g/L |
| Temperature | 25° | C. |
| Current density | 10 | A/dm² |

[Composition of Nickel Plating Solution]

| | | |
|---|---|---|
| Nickel sulfate | 300 | g/L |
| Nickel chloride | 60 | g/L |
| Boric acid | 40 | g/L |
| Temperature | 50° | C. |
| Current density | 5 | A/dm² |

### (7) Precision Polishing Treatment

Then, both the surfaces of the prepared anisotropically conductive member were subjected to mechanical polishing and the anisotropically conductive member resulting therefrom had a thickness of 110 μm.

A ceramic jig (Kemet Japan Co., Ltd.) was used for the sample holder in mechanical polishing and ALCOWAX (Nikka Seiko Co., Ltd.) was used as a material applied to the sample holder. DP-Suspensions P-6 μm·3 μm·1 μm·¼ μm (available from Struers) were used in order for the abrasive.

The ratio of the through micropores filled with metal in the anisotropically conductive member prepared as described above was measured.

More specifically, both the surfaces of the prepared anisotropically conductive member were observed by FE-SEM to see whether or not 1,000 through micropores were filled with metal, thereby calculating the ratio of formation of conductive paths on both the surfaces, and the average was determined therefrom. As a result, the anisotropically conductive members in Examples 1 and 2 had a ratio of 92.6% and 96.2%, respectively.

The thus prepared anisotropically conductive member was cut by FIB in the thickness direction, a cross-sectional image was taken by FE-SEM at a magnification of 50,000× and the interiors of the through micropores were checked. As a result, it was revealed that the interiors of the through micropores where the conductive paths were formed were completely filled with metal.

### (8) Insulating Material Filling Treatment

Then, the anisotropically conductive member prepared as described above was subjected to sealing treatment described below. Sealing treatment involved immersing the anisotropically conductive member in pure water at 80° C. for 1 minute and heating it in an immersed state in an atmosphere at 110° C. for 10 minutes.

### (9) Precision Polishing Treatment

Then, both the surfaces of the sealed anisotropically conductive member were subjected to mechanical polishing similar to precision polishing in (7) and the anisotropically conductive member resulting therefrom had a thickness of 100 μm.

As a result of the calculation of the ratio of formation of conductive paths, the anisotropically conductive members prepared as described above in Examples 1 and 2 had a ratio of 100%.

### (10) Trimming Treatment

The structure having undergone precision polishing treatment was then immersed in a phosphoric acid solution so as to selectively dissolve the anodized film, thereby causing the metal columns serving as the conductive paths to protrude from the surface of the structure.

The same phosphoric acid solution as in the above-described perforating treatment was used, and the treatment time was 1 minute.

### Example 3

Example 1 was repeated except that the high-purity aluminum substrate (Nippon Light Metal Co., Ltd.; purity, 99.9999 wt %; thickness, 0.4 mm) was replaced by a high-purity aluminum substrate (Nippon Light Metal Co., Ltd.; purity, 99.999 wt %; thickness, 0.5 mm) to thereby prepare an anisotropically conductive member with a thickness of 100 μm.

### Example 4

Example 1 was repeated except that the aluminum substrate was anodized in an aqueous malonic acid solution in anodizing treatment in (2) of Example 1 to form the conductive paths with a diameter of 100 nm at a density of 1.3×10⁷ pcs/mm², thereby preparing an anisotropically conductive member with a thickness of 100 μm.

Anodizing treatment was carried out in an electrolytic solution containing 0.50 mol/L of malonic acid under anodizing conditions of a voltage of 115 V, a solution temperature of 3° C. and a time of 13 hours to obtain an anodized film with a thickness of 130 μm.

### Example 5

Example 1 was repeated except that the aluminum substrate was anodized for 54 hours in anodizing treatment in (2) of Example 1 to prepare an anodized film with a thickness of 430 μm, to thereby prepare an anisotropically conductive member with a thickness of 400 μm.

### Example 6

Example 1 was repeated except that mirror-like finishing treatment (electrolytic polishing) in (1) of Example 1 was not carried out, to thereby prepare an anisotropically conductive member with a thickness of 100 μm in Example 6.

### Example 7

Example 1 was repeated except that the high-purity aluminum substrate (Nippon Light Metal Co., Ltd.; purity, 99.9999 wt %; thickness, 0.4 mm) used in Example 1 was replaced by a high-purity aluminum substrate (Nippon Light Metal Co., Ltd.; purity, 99.996 wt %; thickness, 0.5 mm) to thereby prepare an anisotropically conductive member with a thickness of 100 μm.

### Example 8

Example 1 was repeated except that the high-purity aluminum substrate (Nippon Light Metal Co., Ltd.; purity, 99.999 wt %; thickness, 0.5 mm) used in Example 3 was prepared by continuous casting and rolling (CC (continuous casting) process) to reduce the size of the intermetallic compounds to thereby prepare an anisotropically conductive member with a thickness of 100 μm.

### Comparative Example 1

Example 1 was repeated except that the high-purity aluminum substrate (Nippon Light Metal Co., Ltd.; purity, 99.9999 wt %; thickness, 0.4 mm) was replaced by a high-purity aluminum substrate (Sumitomo Light Metal Industries, Ltd.; purity, 99.99 wt %; thickness, 0.4 mm) to thereby prepare an anisotropically conductive member with a thickness of 100 μm.

[Area Ratio of Conductive Path-Free Regions]

A surface of each of the anisotropically conductive members prepared in Examples 1 to 8 and Comparative Example 1 was observed by FE-SEM. The region where no conductive path is formed has a lower electron density than the region where a conductive path is formed and therefore the former can be distinguished from the latter. In other words, the area ratio of regions where no conductive path is formed can be calculated from the resulting SEM image. The area ratio (%) of conductive path-free regions which was obtained from the FE-SEM image taken at a magnification of 2,000× in an observed region of 1 mm×1 mm {(area of conductive path-free regions)/area of the observed region)×100} was as shown in Table 1.

The area ratio of conductive path-free regions is preferably about 0.50% or less from a practical point of view.

[Measurement of Resistivity]

The anisotropically conductive members prepared in Examples 1 to 8 and Comparative Example 1 and preliminarily prepared masks were used to immerse them in an electroless gold plating bath containing PRECIOUSFAB ACG2000 (Tanaka Holdings Co., Ltd.) thereby forming a metal electrode portion 60 with a thickness of 20 μm on each of the front and back surfaces of the anisotropically conductive members as shown in the anisotropically conductive member 1 of FIGS. 6A and 6B. The metal connecting portion had a size of 5 μm×5 μm.

RM3542 (Hioki E.E. Corporation) was used to calculate the resistivity in the thickness direction of the anisotropically conductive member by the four-terminal method via the metal connecting portions formed on the front and back surfaces of the anisotropically conductive member.

The resistivity is to be 1×10⁻⁴ Ωm or less from a practical point of view.

“Density of Intermetallic Compounds” and “Average Circle Equivalent Diameter of Intermetallic Compounds” in Table 1 show numerical values of the density and the average circle equivalent diameter of the intermetallic compounds in the aluminum substrates used, respectively. “Ra of Aluminum Substrate” shows the surface roughness of the aluminum substrates to be anodized.

Exemplary intermetallic compounds contained in the aluminum substrates include CuAl₂ and Al₂Fe.

TABLE 1

| | | | | | | | | | Comparative |
|---|---|---|---|---|---|---|---|---|---|
| | Example 1 | Example 2 | Example 3 | Example 4 | Example 5 | Example 6 | Example 7 | Example 8 | Example 1 |
| Density of Intermetallic Compounds | 10 | 10 | 50 | 10 | 10 | 10 | 80 | 50 | 200 |
| (pcs/mm²) | | | | | | | | | |
| Average Circle Equivalent Diameter | 0.5 | 0.5 | 2 | 0.5 | 0.5 | 0.5 | 2 | 1 | 5 |
| of Intermetallic Compounds (μm) | | | | | | | | | |
| Density of Conductive Paths | 1 × 10⁸ | 1 × 10⁸ | 1 × 10⁸ | 1.3 × 10⁷ | 1 × 10⁸ | 1 × 10⁸ | 1 × 10⁸ | 1 × 10⁸ | 1 × 10⁸ |
| (pcs/mm²) | | | | | | | | | |
| Diameter of Conductive Paths (nm) | 30 | 30 | 30 | 100 | 30 | 30 | 30 | 30 | 30 |
| Thickness of Insulating Base (μm) | 100 | 100 | 100 | 100 | 400 | 100 | 100 | 100 | 100 |
| Ra of Aluminum Substrate (μm) | 0.01 | 0.01 | 0.01 | 0.01 | 0.01 | 0.05 | 0.01 | 0.01 | 0.01 |
| Filled Metal | Cu | Ni | Cu | Cu | Cu | Cu | Cu | Cu | Cu |
| Area Ratio of Conductive Path-Free | 0.001 | 0.001 | 0.020 | 0.025 | 0.004 | 0.018 | 0.050 | 0.020 | 0.90 |
| Regions (%) | | | | | | | | | |
| Resistivity (Ωm) | 3 × 10⁻⁸ | 8 × 10⁻⁸ | 1 × 10⁻⁷ | 1 × 10⁻⁷ | 5 × 10⁻⁸ | 1 × 10⁻⁷ | 1 × 10⁻⁶ | 5 × 10⁻⁸ | 1 × 10⁻³ |
| Electrode size: 5 um × 5 um | | | | | | | | | |

Table 1 revealed that the anisotropically conductive members in Examples 1 to 8 as obtained using aluminum plates which contained intermetallic compounds at a predetermined density exhibit excellent resistivity and are useful as electrically connecting members or inspection connectors for electronic components such as semiconductor devices.

The anisotropically conductive member in Comparative Example 1 obtained using an aluminum plate which contained intermetallic compounds at a predetermined density or more had on its surface many regions where no conductive path was not formed, as a result of which the resistivity was increased. It is hard to use an anisotropically conductive member with such a high resistivity in an electrically connecting member or the like.

What is claimed is:

1. An anisotropically conductive member comprising: an insulating base having through micropores and a plurality of conductive paths formed by filling the through micropores with a conductive material, insulated from one another, and extending through the insulating base in a thickness direction of the insulating base, one end of each of the conductive paths exposed on one side of the insulating base, the other end of each of the conductive paths exposed on the other side thereof,
wherein the insulating base is an anodized film obtained from an aluminum substrate and the aluminum substrate contains intermetallic compounds with an average circle equivalent diameter of up to 2 μm at a density of up to 100 pcs/mm².

2. The anisotropically conductive member according to claim 1, wherein the conductive paths are formed at a density of at least 1×10⁷ pcs/mm².

3. The anisotropically conductive member according to claim 1, wherein the conductive paths have diameters of 5 to 500 nm.

4. The anisotropically conductive member according to claim 1, wherein the insulating base has a thickness of 1 to 1,000 μm.

5. The anisotropically conductive member according to claim 1, wherein the aluminum substrate has an arithmetic mean roughness Ra of up to 0.1 μm.

6. An anisotropically conductive member-manufacturing method for manufacturing the anisotropically conductive member according to claim 1, comprising, at least:
an anodizing treatment step in which an aluminum substrate is anodized;
a perforating treatment step in which micropores formed by anodization are perforated after the anodizing treatment step to obtain an insulating base; and
a filling step in which a conductive material is filled into through micropores in the resulting insulating base after the perforating treatment step to obtain the anisotropically conductive member.

7. The anisotropically conductive member-manufacturing method according to claim 6 which further comprises, after the filling step, a surface planarization step in which a top surface and a back surface are planarized by chemical mechanical polishing.

8. The anisotropically conductive member-manufacturing method according to claim 6 which further comprises a trimming step after the filling step.

9. The anisotropically conductive member according to claim 2, wherein the conductive paths have diameters of 5 to 500 nm.

10. The anisotropically conductive member according to claim 2, wherein the insulating base has a thickness of 1 to 1,000 μm.

11. The anisotropically conductive member according to claim 3, wherein the insulating base has a thickness of 1 to 1,000 μm.

12. The anisotropically conductive member according to claim 2, wherein the aluminum substrate has an arithmetic mean roughness Ra of up to 0.1 μm.

13. The anisotropically conductive member according to claim 3, wherein the aluminum substrate has an arithmetic mean roughness Ra of up to 0.1 μm.

14. The anisotropically conductive member according to claim 4, wherein the aluminum substrate has an arithmetic mean roughness Ra of up to 0.1 μm.

15. An anisotropically conductive member-manufacturing method for manufacturing the anisotropically conductive member according to claim 2, comprising, at least:
an anodizing treatment step in which an aluminum substrate is anodized;
a perforating treatment step in which micropores formed by anodization are perforated after the anodizing treatment step to obtain an insulating base; and
a filling step in which a conductive material is filled into through micropores in the resulting insulating base after the perforating treatment step to obtain the anisotropically conductive member.

16. An anisotropically conductive member-manufacturing method for manufacturing the anisotropically conductive member according to claim 3, comprising, at least:
an anodizing treatment step in which an aluminum substrate is anodized;
a perforating treatment step in which micropores formed by anodization are perforated after the anodizing treatment step to obtain an insulating base; and
a filling step in which a conductive material is filled into through micropores in the resulting insulating base after the perforating treatment step to obtain the anisotropically conductive member.

17. An anisotropically conductive member-manufacturing method for manufacturing the anisotropically conductive member according to claim 4, comprising, at least:
an anodizing treatment step in which an aluminum substrate is anodized;
a perforating treatment step in which micropores formed by anodization are perforated after the anodizing treatment step to obtain an insulating base; and
a filling step in which a conductive material is filled into through micropores in the resulting insulating base after the perforating treatment step to obtain the anisotropically conductive member.

18. An anisotropically conductive member-manufacturing method for manufacturing the anisotropically conductive member according to claim 5, comprising, at least:
an anodizing treatment step in which an aluminum substrate is anodized;
a perforating treatment step in which micropores formed by anodization are perforated after the anodizing treatment step to obtain an insulating base; and
a filling step in which a conductive material is filled into through micropores in the resulting insulating base after the perforating treatment step to obtain the anisotropically conductive member.

19. The anisotropically conductive member-manufacturing method according to claim 7 which further comprises a trimming step after the filling step.
